(19) United States
(12) Patent Application Publication
(10) Pub. No.: US 2022/0134400 A1
(43) Pub. Date: May 5, 2022

(54) PRESS ROLL APPARATUS AND METHOD FOR CONTROLLING PRESS ROLL APPARATUS

(71) Applicant: TOYOTA JIDOSHA KABUSHIKI KAISHA, Toyota-shi (JP)

(72) Inventors: Taichi URAKAMI, Toyota-shi (JP); Shota Murao, Nagakute-shi (JP); Takayuki Ishiguro, Nisshin-shi (JP); Shinichi Yasumoto, Toyota-shi (JP); Seiji Ishizu, Toyota-shi (JP)

(73) Assignee: TOYOTA JIDOSHA KABUSHIKI KAISHA, Toyota-shi (JP)

(21) Appl. No.: 17/504,042

(22) Filed: Oct. 18, 2021

(30) Foreign Application Priority Data
Nov. 4, 2020 (JP) 2020-184385

(51) Int. Cl. B21B 37/58

(52) U.S. Cl. CPC B21B 37/58

(57) ABSTRACT

A first exemplary aspect is a press roll apparatus including: a first roll and a second roll configured to hold a workpiece therebetween to press the workpiece; a mobile unit configured to move the second roll; a detection unit configured to be able to detect a load that acts between the first and the second rolls; and a control unit configured to control the mobile unit. The control unit moves the second roll in a direction in which the second roll approaches the first roll in a state in which the workpiece is not held between the first and the second rolls, and sets a position of the second roll where the load detected by the detection unit has become equal to or greater than a predetermined value as an origin position.

### CROSS REFERENCE TO RELATED APPLICATIONS

This application is based upon and claims the benefit of priority from Japanese patent application No. 2020-184385, filed on Nov. 4, 2020, the disclosure of which is incorporated herein in its entirety by reference.

### BACKGROUND

The present disclosure relates to a press roll apparatus and a method for controlling the press roll apparatus.

In recent years, lithium-ion secondary batteries have been mounted on automobiles, mobile telephones, and the like. In order to manufacture a high-performance lithium-ion secondary battery, it is necessary to form an electrode having a uniform thickness. In general, for the electrode of the lithium-ion secondary battery, a process of pressing the electrode by using a press roll apparatus is provided.

When the electrode is pressed by using the press roll apparatus, the resulting thickness of the electrode after it is pressed is extremely important. Therefore, it is necessary to accurately adjust a gap between rolls of the press roll apparatus. Japanese Unexamined Patent Application Publication No. 2018-149577 discloses a technique for maintaining the parallelism of the shaft centers of the rolls of the press roll apparatus in order to accurately adjust a gap between the rolls thereof.

### SUMMARY

When the gap between the rolls of the press roll apparatus is adjusted, it is necessary to first perform origin alignment of the roll. In the related art, a lead wire is attached to the roll in advance, and then the attached lead wire is pressed by the roll. Then, the thickness of the pressed lead wire is measured, and based on the result of this measurement, origin alignment (zero point correction) is performed.

However, in the case of using such a method, a process of attaching the lead wire to the roll and then a process of measuring the thickness of the lead wire are required, which causes a problem that it takes time to perform the origin alignment. Further, since the thickness of the lead wire is measured and, based on the result of this measurement, the origin alignment is performed, there is a problem that the origin alignment cannot be accurately performed.

In view of the aforementioned problems, an object of the present disclosure is to provide a press roll apparatus capable of accurately performing origin alignment in a short time and a method for controlling the press roll apparatus.

A first exemplary aspect is a press roll apparatus including: a first roll and a second roll configured to hold a workpiece therebetween to press the workpiece; a mobile unit configured to move the second roll; a detection unit configured to be able to detect a load that acts between the first and the second rolls; and a control unit configured to control the mobile unit. The control unit moves the second roll in a direction in which the second roll approaches the first roll in a state in which the workpiece is not held between the first and the second rolls, and sets a position of the second roll where the load detected by the detection unit has become equal to or greater than a predetermined value as an origin position.

In the above-described press roll apparatus, the second roll is moved in a direction in which the second roll approaches the first roll in a state in which the workpiece is not held between the first and the second rolls, and a position of the second roll where the load detected by the detection unit has become equal to or greater than a predetermined value is set as an origin position. In the above-described press roll apparatus, the load that acts between the first and the second rolls is detected by bringing the first roll and the second roll into contact with each other in this above way, whereby the origin position is set. Thus, it is possible to accurately perform the origin alignment in a short time.

In the above-described press roll apparatus, when a distance between rolls is longer than a predetermined distance, the distance between the rolls being a distance between the first and the second rolls, the control unit may make a speed at which the second roll is moved in the direction in which the second roll approaches the first roll higher than that when the distance between the rolls is equal to or less than the predetermined distance.

By increasing the speed at which the second roll is moved when the distance between the first and the second rolls is long in this above way, it is possible to reduce the time required to set the origin position of the second roll. Further, by reducing the speed at which the second roll is moved when the distance between the first and the second roll is reduced, it is possible to prevent or reduce the occurrence of a dent on the first and the second rolls at a position where these rolls come into contact with each other.

The above-described press roll apparatus may further include a heating unit configured to heat at least one of the first and the second rolls, in which the control unit may set the origin position by heating at least one of the first and the second rolls using the heating unit and then moving the second roll in the direction in which the second roll approaches the first roll.

When at least one of the first and the second rolls is heated by using the heating unit and then the origin position is set in this above way, it is possible to align the origin position in a state in which the first and the second rolls are thermally expanded. Thus, it is possible to accurately perform the origin alignment.

The above-described press roll apparatus may further include a gap adjustment unit configured to adjust a gap between the first and the second rolls, in which the control unit may adjust the gap between the first and the second rolls by using the gap adjustment unit after the origin position is set.

By adjusting the gap between the first and the second rolls using the gap adjustment unit after the origin position is set in this above way, it is possible to accurately press the workpiece.

Another exemplary aspect is a method for controlling a press roll apparatus including a first roll and a second roll, the first and the second rolls being configured to hold a workpiece therebetween to press the workpiece, the method including moving the second roll in a direction in which the second roll approaches the first roll in a state in which the workpiece is not held between the first and the second rolls, and setting a position of the second roll where a load that acts between the first and the second rolls has become equal to or greater than a predetermined value as an origin position.

In the above-described method, when a distance between rolls is longer than a predetermined distance, the distance between the rolls being a distance between the first and the second rolls, a speed at which the second roll is moved in the direction in which the second roll approaches the first roll may be made higher than that when the distance between the rolls is equal to or less than the predetermined distance.

In the above-described method, the press roll apparatus may further include a heating unit configured to heat at least one of the first and the second rolls, and the origin position may be set by heating at least one of the first and the second rolls using the heating unit and then moving the second roll in the direction in which the second roll approaches the first roll.

In the above-described method, the press roll apparatus may further include a gap adjustment unit configured to adjust a gap between the first and the second rolls, and the gap between the first and the second rolls may be adjusted by using the gap adjustment unit after the origin position is set.

According to the present disclosure, it is possible to provide a press roll apparatus capable of accurately performing origin alignment in a short time and a method for controlling the press roll apparatus.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a cross-sectional view for explaining a press roll apparatus according to a first embodiment;

FIG. 2 is a cross-sectional view for explaining the press roll apparatus according to the first embodiment;

FIG. 3A is a cross-sectional view for explaining an operation of the press roll apparatus according to the first embodiment;

FIG. 3B is a cross-sectional view for explaining the operation of the press roll apparatus according to the first embodiment;

FIG. 3C is a cross-sectional view for explaining the operation of the press roll apparatus according to the first embodiment;

FIG. 3D is a cross-sectional view for explaining the operation of the press roll apparatus according to the first embodiment;

FIG. 4 is a cross-sectional view for explaining a press roll apparatus according to a second embodiment;

FIG. 5 is a cross-sectional view for explaining the press roll apparatus according to the second embodiment;

FIG. 6A is a cross-sectional view for explaining an operation of the press roll apparatus according to the second embodiment;

FIG. 6B is a cross-sectional view for explaining the operation of the press roll apparatus according to the second embodiment;

FIG. 6C is a cross-sectional view for explaining the operation of the press roll apparatus according to the second embodiment; and

FIG. 6D is a cross-sectional view for explaining the operation of the press roll apparatus according to the second embodiment.

### DESCRIPTION OF EMBODIMENTS

### First Embodiment

Hereinafter, embodiments of the present disclosure will be described with reference to the drawings.

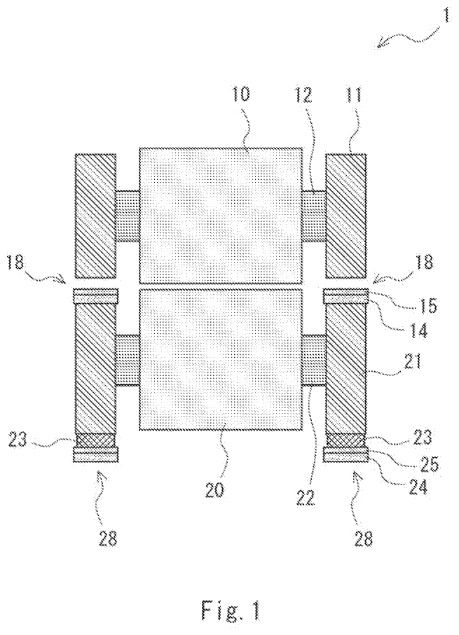

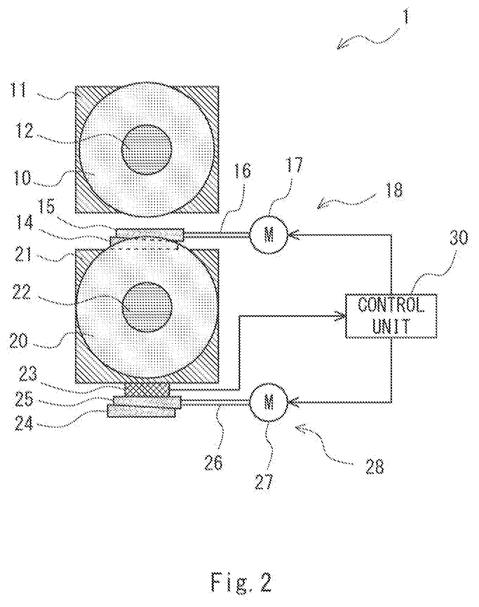

FIGS. 1 and 2 are cross-sectional views for explaining a press roll apparatus according to a first embodiment. FIG. 1 is a cross-sectional view of the press roll apparatus when viewed from the front thereof, and FIG. 2 is a cross-sectional view of the press roll apparatus when viewed from the side thereof. As shown in FIGS. 1 and 2, a press roll apparatus 1 according to this embodiment includes an upper roll (a first roll) 10, an upper housing 11, an upper roll shaft 12, a lower roll (a second roll) 20, a lower housing 21, a lower roll shaft 22, a detection unit 23, a gap adjustment unit 18, and a mobile unit 28.

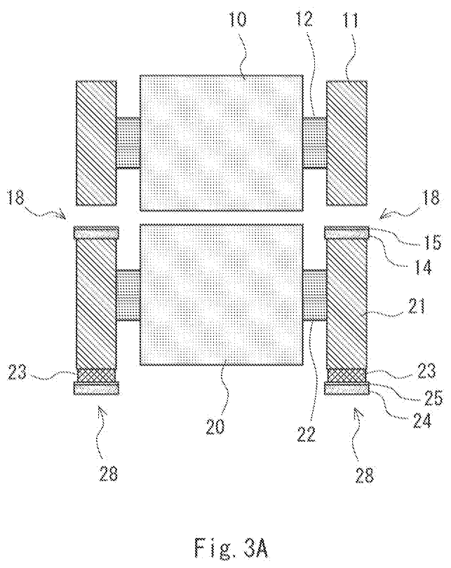

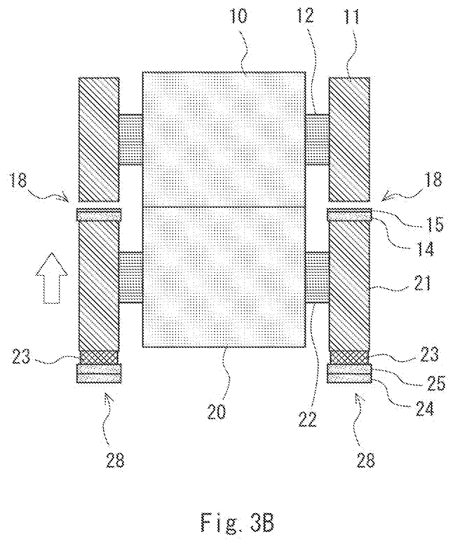

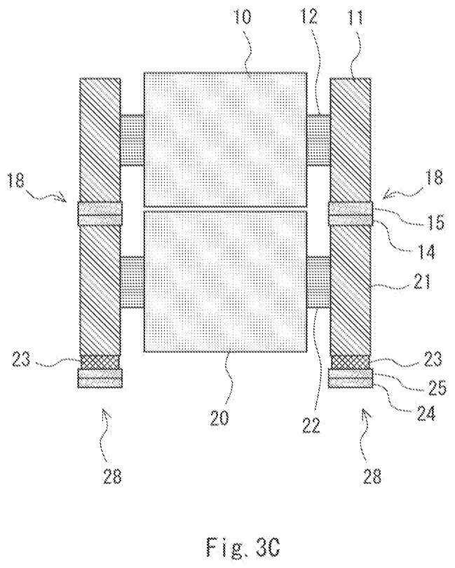

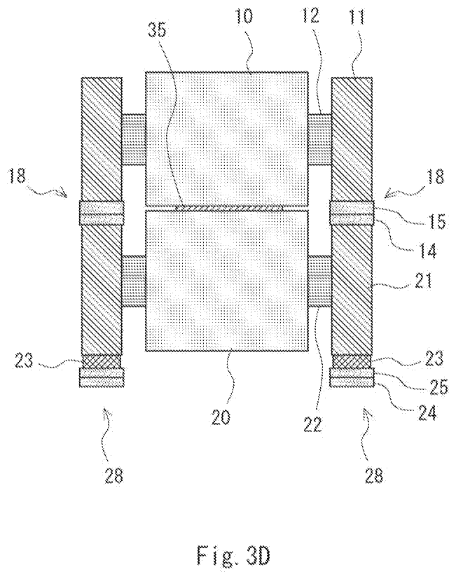

The press roll apparatus 1 according to this embodiment is configured so that the upper roll 10 and the lower roll 20 hold a workpiece 35 (see FIG. 3D) therebetween to press it. That is, a gap (a space) is formed between the upper roll 10 and the lower roll 20, and the sheet-like workpiece 35 passes between the upper roll 10 and the lower roll 20, whereby the workpiece 35 is continuously pressed.

The upper roll 10 is rotatably fixed to the upper housing 11 by using the upper roll shaft 12. The lower roll 20 is rotatably fixed to the lower housing 21 by using the lower roll shaft 22. The rotation shaft of the upper roll 10 and the rotation shaft of the lower roll 20 are configured to be parallel to each other.

In the press roll apparatus 1 according to this embodiment, the upper housing 11 is fixed to the main body (not shown) of the apparatus. Further, the lower housing 21 is fixed to the main body (not shown) of the apparatus and is configured to be movable in the up-down direction (the vertical direction) thereof. Therefore, by moving the lower housing 21 in the up-down direction using the mobile unit 28, it is possible to adjust the distance between the upper roll 10 and the lower roll 20.

As shown in FIG. 2, the mobile unit 28 is configured by using a lower wedge 24, an upper wedge 25, a shaft 26, and a drive unit 27. The lower wedge 24 is fixed to the main body (not shown) of the apparatus. The upper surface of the lower wedge 24 is inclined so that the thickness of the lower wedge 24 becomes thinner toward the right side thereof. The upper wedge 25 is provided so that it comes into contact with the lower wedge 24 on the upper side of the lower wedge 24. The lower surface of the upper wedge 25 is inclined so that the thickness of the upper wedge 25 becomes thinner toward the left side thereof. That is, the surfaces of the upper wedge 25 and the lower wedge 24 that are in contact with each other are inclined.

The upper wedge 25 is coupled to the shaft 26. The shaft 26 is configured to be movable in the right-left direction in the figure by using the drive unit 27. Therefore, the mobile unit 28 can move the lower housing 21 in the up-down direction by moving the upper wedge 25 (the shaft 26) in the right-left direction in the figure using the drive unit 27. Specifically, the mobile unit 28 can move the lower housing 21 upward by moving the upper wedge 25 (the shaft 26) leftward in the figure using the drive unit 27. Further, the mobile unit 28 can move the lower housing 21 downward by moving the upper wedge 25 (the shaft 26) rightward in the figure using the drive unit 27.

The drive unit 27 can be configured by using, for example, a servo motor. The drive unit 27 is connected to a control unit 30, and the drive unit 27 is driven in response to a control signal from the control unit 30. For example, the mobile unit 28 may move the lower housing 21 upward while limiting the torque so that the drive unit 27 (the servo motor) does not exceed a predetermined torque value.

As shown in FIG. 1, the press roll apparatus 1 according to this embodiment has a symmetrical structure, and the mobile units 28 are respectively provided on the left and the right sides of the press roll apparatus 1. For example, each of the left and the right mobile units 28 may be raised at a constant speed so that the lower roll 20 does not tilt while encoder values of the left and the right drive units 27 (the servomotors) are being synchronized with each other. Further, by independently controlling the left and the right mobile units 28, it is possible to adjust the angle of the lower roll 20 with respect to the horizontal plane.

The detection unit 23 is configured to detect a load that acts between the upper roll 10 and the lower roll 20. In the configuration examples shown in FIGS. 1 and 2, the detection unit 23 is provided between the lower housing 21 and the mobile unit 28 (the upper wedge 25). Therefore, the detection unit 23 can measure a load transmitted from the lower housing 21.

For example, when the upper roll 10 and the lower roll 20 are not in contact with each other and the upper housing 11 and the gap adjustment unit 18 are not in contact with each other (hereinafter referred to as state A), the detection unit 23 detects a load (a load A) of the lower roll 20, the lower housing 21, the lower roll shaft 22, and the gap adjustment unit 18 as the load transmitted from the lower housing 21.

Further, when the upper roll 10 and the lower roll 20 are in contact with each other in a state in which the upper housing 11 and the gap adjustment unit 18 are not in contact with each other (hereinafter referred to as a state B), the detection unit 23 detects a load (the load A+a load B) obtained by combining the load (the load A) of the lower roll 20, the lower housing 21, the lower roll shaft 22, and the gap adjustment unit 18 with the load (the load B) that acts between the upper roll 10 and the lower roll 20 as the load transmitted from the lower housing 21. In this case, by subtracting the load (the load A) of the lower roll 20, the lower housing 21, the lower roll shaft 22, and the gap adjustment unit 18 from the load (the load A+the load B) detected by the detection unit 23, the load (the load B) that acts between the upper roll 10 and the lower roll 20 can be obtained.

Further, when the upper roll 10 and the lower roll 20 are not in contact with each other and the upper housing 11 and the gap adjustment unit 18 are in contact with each other (hereinafter referred to as a state C), the detection unit 23 detects a load (the load A+a load C) obtained by combining the load (the load A) of the lower roll 20, the lower housing 21, the lower roll shaft 22, and the gap adjustment unit 18 and the load (the load C) transmitted from the upper housing 11 to the gap adjustment unit 18 as the load transmitted from the lower housing 21.

For example, the detection unit 23 is configured by using a load cell. Load information detected by the detection unit 23 is supplied to the control unit 30.

The gap adjustment unit 18 is configured so that it can adjust a gap between the upper roll 10 and the lower roll 20. For an electrode of a lithium-ion secondary battery, an all-solid-state battery, or the like, a process of pressing the electrode by using a press roll apparatus is provided. When the electrode is pressed by using the press roll apparatus, the resulting thickness of the electrode after it is pressed is extremely important. Therefore, it is necessary to accurately adjust a gap between rolls of the press roll apparatus. In the press roll apparatus 1 according to this embodiment, by adjusting a gap between the upper roll 10 and the lower roll 20 using the gap adjustment unit 18, it is possible to adjust a load applied to the workpiece 35 at the time of pressing of it and the thickness of the workpiece 35 after the pressing of it.

As shown in FIG. 2, the gap adjustment unit 18 is configured by using a lower wedge 14, an upper wedge 15, a shaft 16, and a drive unit 17. The lower wedge 14 is fixed to the upper surface of the lower housing 21. The upper surface of the lower wedge 14 is inclined so that the thickness of the lower wedge 14 becomes thinner toward the right side thereof. The upper wedge 15 is provided so that it comes into contact with the lower wedge 14 on the upper side of the lower wedge 14. The lower surface of the upper wedge 15 is inclined so that the thickness of the upper wedge 15 becomes thinner toward the left side thereof. That is, the surfaces of the upper wedge 15 and the lower wedge 14 that are in contact with each other are inclined.

The upper wedge 15 is coupled to the shaft 16. The shaft 16 is configured to be movable in the right-left direction in the figure by using the drive unit 17. Therefore, the gap adjustment unit 18 can adjust a gap between the upper roll 10 and the lower roll 20 by moving the upper wedge 15 (the shaft 16) in the right-left direction in the figure using the drive unit 17. Specifically, the gap adjustment unit 18 can widen the gap between the upper roll 10 and the lower roll 20 by moving the upper wedge 15 (the shaft 16) leftward in the figure using the drive unit 17. Further, the gap adjustment unit 18 can narrow the gap between the upper roll 10 and the lower roll 20 by moving the upper wedge 15 (the shaft 16) rightward in the figure using the drive unit 17.

The drive unit 17 can be configured by using, for example, a servo motor. The drive unit 17 is connected to the control unit 30, and the drive unit 17 is driven in response to a control signal from the control unit 30.

As shown in FIG. 1, the gap adjustment units 18 are respectively provided on the left and the right sides of the press roll apparatus 1. Thus, by independently controlling the left and the right gap adjustment units 18, it is possible to accurately adjust the gap between the upper roll 10 and the lower roll 20.

The control unit 30 controls the press roll apparatus 1 according to this embodiment. Specifically, the control unit 30 is configured so that it can control the gap adjustment unit 18 and the mobile unit 28. Load information detected by the detection unit 23 is supplied to the control unit 30. Therefore, the control unit 30 can control the gap adjustment unit 18 and the mobile unit 28 in accordance with the load information supplied from the detection unit 23.

The control unit 30 may move the lower roll 20 in a direction in which the lower roll 20 approaches the upper roll 10 in a state in which the workpiece 35 is not held between the upper roll 10 and the lower roll 20, and set a position of the lower roll 20 where the load detected by the detection unit 23 has become equal to or greater than a predetermined value as an origin position. At this time, when a distance between rolls is longer than a predetermined distance, the distance between the rolls being a distance between the upper roll 10 and the lower roll 20, the control unit 30 may make a speed at which the lower roll 20 is moved in the direction in which the lower roll 20 approaches the upper roll 10 higher than that when the distance between the rolls is equal to or less than the predetermined distance. Further, the control unit 30 may adjust a gap between the upper roll 10 and the lower roll 20 by using the gap adjustment unit 18 after the origin position is set.

Next, an operation (a control method) of the press roll apparatus 1 according to this embodiment will be described with reference to FIGS. 3A to 3D.

As shown in FIG. 3A, first, the control unit 30 of the press roll apparatus 1 sets the gap adjustment unit 18 in an initial position. Here, the initial position of the gap adjustment unit 18 is a position where the upper housing 11 and the gap adjustment unit 18 are not in contact with each other (i.e., a space is present between the upper housing 11 and the upper wedge 15) in a state in which the upper roll 10 and the lower roll 20 are in contact with each other (see FIG. 3B). Further, at this time, the workpiece 35 is not held between the upper roll 10 and the lower roll 20.

Next, as shown in FIG. 3B, the control unit 30 raises the lower roll 20 by using the mobile unit 28. Then, when the load detected by the detection unit 23 becomes equal to or greater than a predetermined value, the control unit 30 stops raising the lower roll 20 and sets this position where the raising of the lower roll 20 is stopped as an origin position. In other words, the control unit 30 sets a position of the lower roll 20 where the load that acts between the upper roll 10 and the lower roll 20 has become equal to or greater than a predetermined value as the origin position. The predetermined value at this time is set to a load that is low enough to prevent scratches from being left even when the upper roll 10 and the lower roll 20 come into contact with each other.

Specifically, as shown in FIG. 3B, when the upper roll 10 and the lower roll 20 are in contact with each other in a state in which the upper housing 11 and the gap adjustment unit 18 are not in contact with each other (the state B), the detection unit 23 detects a load (the load A+the load B) obtained by combining the load (the load A) of the lower roll 20, the lower housing 21, the lower roll shaft 22, and the gap adjustment unit 18 with the load (the load B) that acts between the upper roll 10 and the lower roll 20 as the load transmitted from the lower housing 21. In this case, by subtracting the load (the load A) of the lower roll 20, the lower housing 21, the lower roll shaft 22, and the gap adjustment unit 18 from the load (the load A+the load B) detected by the detection unit 23, the load (the load B) that acts between the upper roll 10 and the lower roll 20 can be obtained.

The control unit 30 may use the above-described load A+load B or the above-described load B as the load detected by the detection unit 23. Specifically, when the load (the load A+the load B) detected by the detection unit 23 becomes equal to or greater than a predetermined value, the control unit 30 stops raising the lower roll 20 and sets this position where the raising of the lower roll 20 is stopped as the origin position. Further, when the load (the load B) detected by the detection unit 23 becomes equal to or greater than a predetermined value, the control unit 30 stops raising the lower roll 20 and sets this position where the raising of the lower roll 20 as the origin position.

At this time, when a distance between rolls is longer than a predetermined distance, the distance between the rolls being a distance between the upper roll 10 and the lower roll 20, the control unit 30 may make a speed at which the lower roll 20 is raised higher than that when the distance between the rolls is equal to or less than the predetermined distance. That is, the control unit 30 may increase the speed at which the lower roll 20 is raised when the distance between the upper roll 10 and the lower roll 20 is long, and then reduce the speed at which the lower roll 20 is raised when the distance between the upper roll 10 and the lower roll 20 is reduced.

As described above, by increasing the speed at which the lower roll 20 is raised when the distance between the upper roll 10 and the lower roll 20 is long, it is possible to reduce the time required to set the origin position of the lower roll 20. Further, by reducing the speed at which the lower roll 20 is raised when the distance between the upper roll 10 and the lower roll 20 is reduced, it is possible to prevent or reduce the occurrence of a dent on the upper roll 10 and the lower roll 20 at a position where these rolls come into contact with each other.

By the operations described above, the origin position of the lower roll 20 is set.

After that, as shown in FIG. 3C, the control unit 30 adjusts a gap between the upper roll 10 and the lower roll 20 by using the gap adjustment unit 18. Specifically, the control unit 30 adjusts the position of the upper wedge 15 (the shaft 16) by using the drive unit 17 of the gap adjustment unit 18, thereby adjusting the gap between the upper roll 10 and the lower roll 20.

After that, as shown in FIG. 3D, the upper roll 10 and the lower roll 20 hold the workpiece 35 therebetween to press it. That is, the sheet-like workpiece 35 passes through the gap (the space) between the upper roll 10 and the lower roll 20, whereby the workpiece 35 is continuously pressed.

As described above, in the press roll apparatus 1 according to this embodiment, the lower roll 20 is moved in a direction in which the lower roll 20 approaches the upper roll 10 in a state in which the workpiece 35 is not held between the upper roll 10 and the lower roll 20, and a position of the lower roll 20 where the load detected by the detection unit 23 has become equal to or greater than a predetermined value is set as an origin position. In this embodiment, the load that acts between the upper roll 10 and the lower roll 20 is detected by bringing the upper roll 10 and the lower roll 20 into contact with each other in this above way, whereby the origin position is set. Thus, it is possible to accurately perform the origin alignment in a short time.

### Second Embodiment

Next, a second embodiment of the present disclosure will be described.

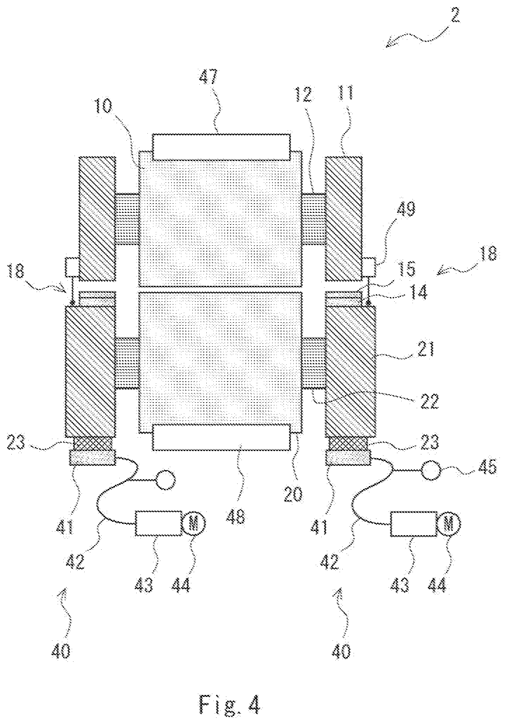

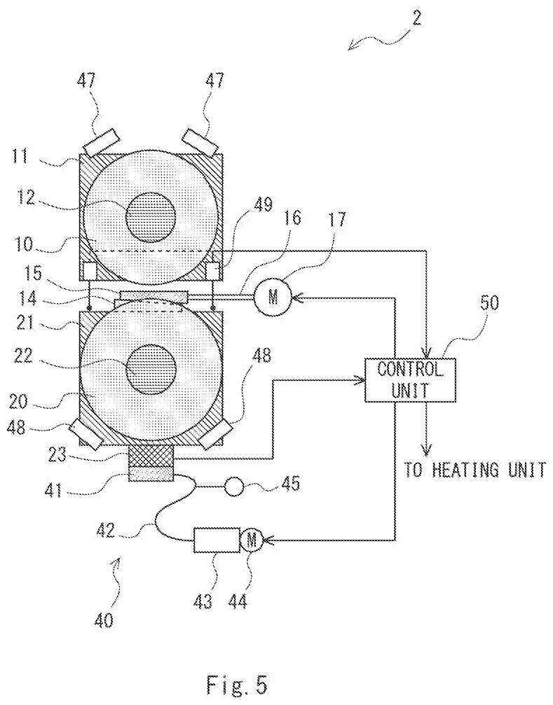

FIGS. 4 and 5 are cross-sectional views for explaining a press roll apparatus according to the second embodiment. FIG. 4 is a cross-sectional view of the press roll apparatus when viewed from the front thereof, and FIG. 5 is a cross-sectional view of the press roll apparatus when viewed from the side thereof. As shown in FIGS. 4 and 5, a press roll apparatus 2 according to this embodiment includes the upper roll 10, the upper housing 11, the upper roll shaft 12, the lower roll 20, the lower housing 21, the lower roll shaft 22, the detection unit 23, the gap adjustment unit 18, a mobile unit 40, heating units 47 and 48, and a position sensor 49.

Note that the press roll apparatus 2 according to this embodiment differs from the press roll apparatus 1 according to the first embodiment in that the press roll apparatus 2 includes the mobile unit 40, the heating units 47 and 48, and the position sensor 49. Since the rest of the configuration and operation are the same as those of the press roll apparatus 1 described in the first embodiment, the same components are denoted by the same reference numerals, and redundant descriptions thereof will be omitted.

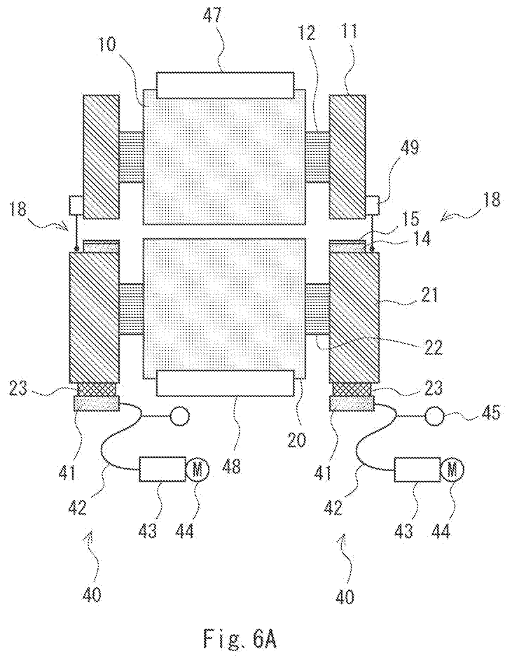

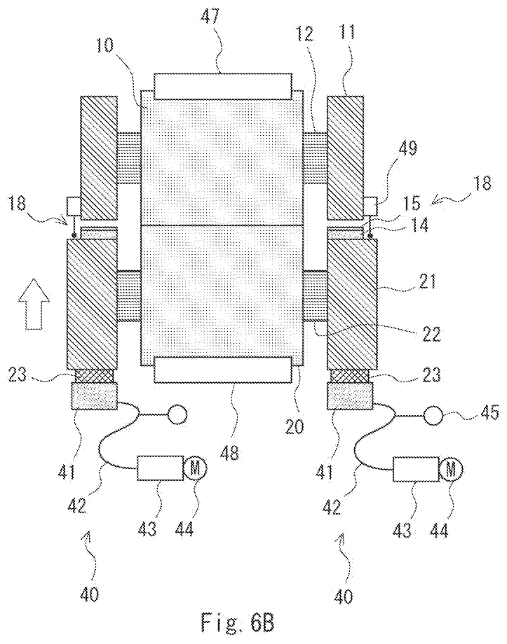

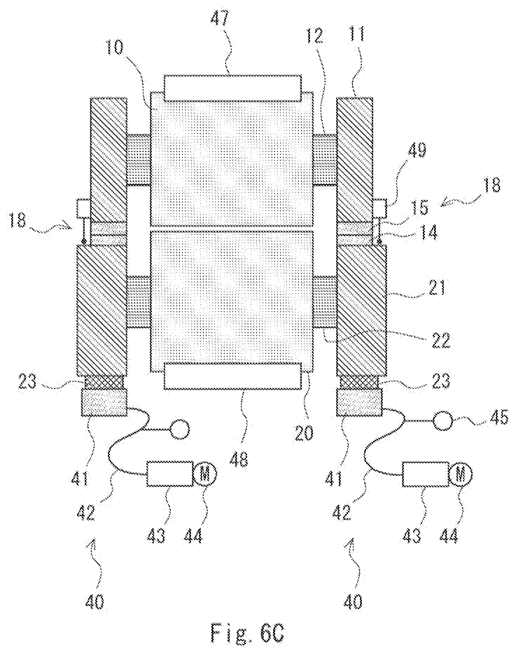

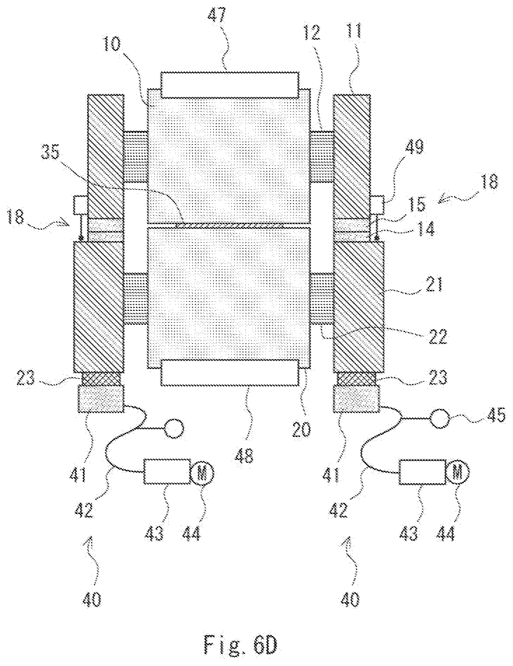

The press roll apparatus 2 according to this embodiment, like the press roll apparatus 1 according to the first embodiment, is configured so that the upper roll 10 and the lower roll 20 hold the workpiece 35 (see FIG. 6D) therebetween to press it. That is, a gap is formed between the upper roll 10 and the lower roll 20, and the sheet-like workpiece 35 passes between the upper roll 10 and the lower roll 20, whereby the workpiece 35 is continuously pressed.

The mobile unit 40 provided in the press roll apparatus 2 according to this embodiment is configured by using a hydraulic system. By configuring the mobile unit 40 using a hydraulic system, a load higher than that of the mobile unit 28 according to the first embodiment can be applied to the workpiece 35.

The mobile unit 40 includes an actuator 41, a pipe 42, a hydraulic pump 43, a hydraulic servo 44, and a hydraulic sensor 45. The hydraulic pump 43 is connected to the actuator 41 through the pipe 42. The actuator 41 is configured to move in the up-down direction in accordance with hydraulic pressure transmitted from the pipe 42. The hydraulic pump 43 is driven by using the hydraulic servo 44. The hydraulic servo 44 controls the hydraulic pump 43 in accordance with control of a control unit 50. The hydraulic sensor 45 detects the hydraulic pressure (the pressure) of the pipe 42.

That is, in this embodiment, the control unit 50 drives the hydraulic servo 44 to control the hydraulic pump 43. By doing so, the pressure of the hydraulic pump 43 is transmitted to the actuator 41 through the pipe 42. Further, the actuator 41 moves in the up-down direction in accordance with the hydraulic pressure transmitted from the pipe 42, whereby it is possible to move the lower housing 21 in the up-down direction. Specifically, by driving the hydraulic servo 44 so that the pressure in the pipe 42 increases, it is possible to move the lower housing 21 upward. For example, the mobile unit 40 may move the lower housing 21 upward while controlling the hydraulic servo 44 so that the hydraulic sensor 45 does not exceed a predetermined pressure. Further, by driving the hydraulic servo 44 so that the pressure in the pipe 42 is reduced, it is possible to move the lower housing 21 downward.

In this embodiment, a position of the lower housing 21 in the up-down direction is detected by using the position sensor 49. The position sensor 49 is provided on each of the side surfaces of the upper housing 11, and measure a distance between the upper housing 11 and the lower housing 21 on both of the side surfaces of the press roll apparatus 2. Since the upper housing 11 is fixed to the main body (not shown) of the apparatus, the position of the lower housing 21 in the up-down direction can be detected by measuring the distance between the upper housing 11 and the lower housing 21. The position sensor 49 can be configured by using, for example, a digital scale.

Position information detected by the position sensor 49 is supplied to the control unit 50. The control unit 50 drives the hydraulic servos 44 on both sides of the lower housing 21 based on the position information (the position information of the lower housing 21) detected by the position sensor 49. By doing so, it is possible to move the lower housing 21 in the up-down direction while keeping the lower roll 20 horizontal.

The press roll apparatus 2 according to this embodiment includes the heating units 47 and 48. The heating unit 47 is provided obliquely above the upper roll 10, and is configured so that it can heat the upper roll 10. The heating unit 48 is provided obliquely below the lower roll 20, and is configured so that it can heat the lower roll 20. For example, the heating units 47 and 48 can be configured by using induction heating coils. The heating units 47 and 48 are connected to the control unit 50, and heat the upper roll 10 and the lower roll 20, respectively, in accordance with the control of the control unit 50. By heating the upper roll 10 and the lower roll 20 using the heating units 47 and 48, it is possible to press the workpiece 35 while the workpiece 35 being heated. Note that the heating units 47 and 48 may be provided only on one of the upper roll 10 and the lower roll 20.

Note that the detection unit 23 and the gap adjustment unit 18 provided in the press roll apparatus 2 according to this embodiment are similar to those provided in the press roll apparatus 1 according to the first embodiment, and thus redundant descriptions thereof will be omitted.

Next, an operation (a control method) of the press roll apparatus 2 according to this embodiment will be described with reference to FIGS. 6A to 6D.

As shown in FIG. 6A, first, the control unit 50 of the press roll apparatus 2 sets the gap adjustment unit 18 in an initial position. At this time, the workpiece 35 is not held between the upper roll 10 and the lower roll 20. Further, the upper roll 10 and the lower roll 20 are heated by using the heating units 47 and 48. At this time, only one of the upper roll 10 and the lower roll 20 may be heated. When both the upper roll 10 and the lower roll 20 are heated, they may each be heated while being rotated.

After the upper roll 10 and the lower roll 20 are heated by using the heating units 47 and 48, in other words, after the respective temperatures of the upper roll 10 and the lower roll 20 are increased to predetermined temperatures, the control unit 50 raises the lower roll 20 by using the mobile unit 40 as shown in FIG. 6B. Then, when the load detected by the detection unit 23 becomes equal to or greater than a predetermined value, the control unit 50 stops raising the lower roll 20 and sets this position where the raising of the lower roll 20 is stopped as an origin position. In other words, the control unit 50 sets a position of the lower roll 20 where the load that acts between the upper roll 10 and the lower roll 20 has become equal to or greater than a predetermined value as the origin position. The predetermined value at this time is set to a load that is low enough to prevent scratches from being left even when the upper roll 10 and the lower roll 20 come into contact with each other. Note that the details of the operation in this case are similar to those in the case of the first embodiment.

At this time, when a distance between rolls is longer than a predetermined distance, the distance between the rolls being a distance between the upper roll 10 and the lower roll 20, the control unit 50 may make a speed at which the lower roll 20 is moved in the direction in which the lower roll 20 approaches the upper roll 10 higher than that when the distance between the rolls is equal to or less than the predetermined distance. That is, when the distance between the upper roll 10 and the lower roll 20 is long, the control unit 50 may increase the speed at which the lower roll 20 is raised, and then reduce the speed at which the lower roll 20 is raised when the distance between the upper roll 10 and the lower roll 20 is reduced.

By increasing the speed at which the lower roll 20 is raised when the distance between the upper roll 10 and the lower roll 20 is long in this above way, it is possible to reduce the time required to set the origin position of the lower roll 20. Further, by reducing the speed at which the lower roll 20 is raised when the distance between the upper roll 10 and the lower roll 20 is reduced, it is possible to prevent or reduce the occurrence of a dent on the upper roll 10 and the lower roll 20 at a position where these rolls come into contact with each other.

By the operations described above, the origin position of the lower roll 20 is set.

After that, as shown in FIG. 6C, the control unit 50 adjusts a gap between the upper roll 10 and the lower roll 20 by using the gap adjustment unit 18. Specifically, the control unit 50 adjusts the position of the upper wedge 15 (the shaft 16) by using the drive unit 17 of the gap adjustment unit 18, thereby adjusting the gap between the upper roll 10 and the lower roll 20.

After that, as shown in FIG. 6D, the upper roll 10 and the lower roll 20 hold the workpiece 35 therebetween to press it. That is, the sheet-like workpiece 35 passes through the gap (the space) between the upper roll 10 and the lower roll 20, whereby the workpiece 35 is continuously pressed.

As described above, in the press roll apparatus 2 according to this embodiment, like in the press roll apparatus 1 according to the first embodiment, the lower roll 20 is moved in a direction in which the lower roll 20 approaches the upper roll 10 in a state in which the workpiece 35 is not held between the upper roll 10 and the lower roll 20, and a position of the lower roll 20 where the load detected by the detection unit 23 has become equal to or greater than a predetermined value is set as an origin position. As described above, in this embodiment, the load that acts between the upper roll 10 and the lower roll 20 is detected by bringing the upper roll 10 and the lower roll 20 into contact with each other, whereby the origin position is set. Thus, it is possible to accurately perform the origin alignment in a short time.

Further, in the press roll apparatus 2 according to this embodiment, the upper roll 10 and the lower roll 20 are heated by using the heating units 47 and 48 and then the lower roll 20 is raised by using the mobile unit 40, whereby the origin position is set. Thus, it is possible to align the origin position in a state in which the upper roll 10 and the lower roll 20 are thermally expanded, and it is therefore possible to accurately perform the origin alignment.

That is, in a conventional method, when the origin alignment is to be performed, a lead wire is attached to the roll in advance, and therefore it can be performed only at room temperature. Therefore, it is necessary to correct the origin position based on the amount of thermal expansion of the roll. In contrast, in this embodiment, the origin position is set after the upper roll 10 and the lower roll 20 are heated. Thus, it is possible to align the origin position in a state in which the upper roll 10 and the lower roll 20 are thermally expanded, and it is therefore possible to accurately perform the origin alignment.

Note that the present disclosure is not limited to the above-described embodiments and may be modified as appropriate without departing from the spirit of the present disclosure. For example, the above-described embodiments provide an example in which the mobile units 28 and 40 are configured by a servomotor and a hydraulic system. However, in the present disclosure, any means capable of moving the lower housing 21 in the up-down direction may be used as the mobile unit. Further, the above-described embodiments show a configuration in which the heating units 47 and 48 are provided in the press roll apparatus 2 according to the second embodiment. However, in the present disclosure, the heating units 47 and 48 may be provided in the press roll apparatus 1 according to the first embodiment.

Further, in the above-described embodiments, a configuration in which the lower housing 21 is moved in the up-down direction has been described. However, in the present disclosure, a configuration in which the upper housing 11 is moved in the up-down direction may instead be employed. In this case, a mobile unit that moves the upper housing 11 in the up-down direction is provided. Further, the control units 30 and 50 move the upper roll (the second roll) 10 in a direction in which the upper roll 10 approaches the lower roll (the first roll) 20 in a state in which the workpiece 35 is not held between the upper roll 10 and the lower roll 20, and set a position of the upper roll 10 where the load that acts between the upper roll 10 and the lower roll 20 has become equal to or greater than a predetermined value as the origin position.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A press roll apparatus comprising:
a first roll and a second roll configured to hold a workpiece therebetween to press the workpiece;
a mobile unit configured to move the second roll;
a detection unit configured to be able to detect a load that acts between the first and the second rolls; and
a control unit configured to control the mobile unit,
wherein the control unit moves the second roll in a direction in which the second roll approaches the first roll in a state in which the workpiece is not held between the first and the second rolls, and sets a position of the second roll where the load detected by the detection unit has become equal to or greater than a predetermined value as an origin position.

2. The press roll apparatus according to claim 1, wherein when a distance between rolls is longer than a predetermined distance, the distance between the rolls being a distance between the first and the second rolls, the control unit makes a speed at which the second roll is moved in the direction in which the second roll approaches the first roll higher than that when the distance between the rolls is equal to or less than the predetermined distance.

3. The press roll apparatus according to claim 1, further comprising a heating unit configured to heat at least one of the first and the second rolls,
wherein the control unit sets the origin position by heating at least one of the first and the second rolls using the heating unit and then moving the second roll in the direction in which the second roll approaches the first roll.

4. The press roll apparatus according to claim 1, further comprising a gap adjustment unit configured to adjust a gap between the first and the second rolls,
wherein the control unit adjusts the gap between the first and the second rolls by using the gap adjustment unit after the origin position is set.

5. A method for controlling a press roll apparatus comprising a first roll and a second roll, the first and the second rolls being configured to hold a workpiece therebetween to press the workpiece, the method comprising
moving the second roll in a direction in which the second roll approaches the first roll in a state in which the workpiece is not held between the first and the second rolls, and setting a position of the second roll where a load that acts between the first and the second rolls has become equal to or greater than a predetermined value as an origin position.

6. The method according to claim 5, wherein when a distance between rolls is longer than a predetermined distance, the distance between the rolls being a distance between the first and the second rolls, a speed at which the second roll is moved in the direction in which the second roll approaches the first roll is made higher than that when the distance between the rolls is equal to or less than the predetermined distance.

7. The method according to claim 5, wherein
the press roll apparatus further comprises a heating unit configured to heat at least one of the first and the second rolls, and
the origin position is set by heating at least one of the first and the second rolls using the heating unit and then moving the second roll in the direction in which the second roll approaches the first roll.

8. The method according to claim 5, wherein
the press roll apparatus further comprises a gap adjustment unit configured to adjust a gap between the first and the second rolls, and
the gap between the first and the second rolls is adjusted by using the gap adjustment unit after the origin position is set.
